(19) United States
(12) Patent Application Publication
(10) Pub. No.: US 2007/0145110 A1
(43) Pub. Date: Jun. 28, 2007

(54) Method and carrier information system for transferring information to a target device

(76) Inventors: Lisa D. Kelley, Davie, FL (US); Charles P. Schultz, North Miami Beach, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/320,400

(22) Filed: Dec. 28, 2005

(51) Int. Cl. G06F 17/00

(52) U.S. Cl. 235/375

(57) ABSTRACT

A method and carrier information system (500) for transferring information to at least one target device is provided. The method can include receiving (105) a request for contact information from a requesting device. The method can further include transferring (110) at least a portion of the contact information to a contact information database of the target device in response to receiving the request. The contact information can include a phone number, a facsimile number, a physical address, an email address, a universal resource locator (URL), directions to a location or an image.

### FIELD OF THE INVENTION

The invention relates to carrier information systems. More specifically, the invention relates to a method and carrier information system for transferring information to a target device.

### BACKGROUND OF THE INVENTION

Conventionally, a user contacts an operator of a carrier information system to get the contact details of a person or business. If later the user requires the contact details of the person or business, then the user may need to contact the carrier information system again, which can be a significant inconvenience for the user.

### SUMMARY OF THE INVENTION

The invention provides a method for transferring information to at least one target device. The method can include receiving a request for contact information from a requesting device. The method can further include transferring at least a portion of the contact information to a contact information database of the target device in response to receiving the request. As an example, the transferring step may include assigning an available speed dial to the contact information in the target device.

The target device may be, for example, a wireless device. As another example, the wireless device may be a mobile phone, a personal digital assistant (PDA), a digital camera, a media player or a gaming unit. The contact information may include, for example, a phone number, a facsimile number, a physical address, an email address, a universal resource locator (URL), directions to a location or an image.

The target device may be or include the requesting device. In an embodiment of the invention, the target device can include at least one selective dynamic group call (SDGC)-device. The SDGC-device can belong to an SDGC group of the requesting device. In another embodiment of the invention, the target device can include at least one related device. A reference that corresponds to a related device can be stored in a profile of the target device.

The method may further include providing related information to the target device. The related information may include, for example, directions to a physical address corresponding to the contact information, global positioning system (GPS) co-ordinates of the physical address, an audio file corresponding to the contact information, a phonebook icon corresponding to the contact information or a signature ring tone corresponding to the contact information. The method to provide directions to the physical address to a target device may include obtaining the location of the target device, retrieving the directions based on the location of the target device and sending the directions to the target device.

In an embodiment of the invention, the method can further include requesting permission from the user of the target device and transferring the information to the target device if the user provides the requested permission. The method may further include further include charging a fee for the request of contact information. The term charging a fee may include a direct charge to a customer's account to be paid in the future or deducting value from a prepaid account.

The invention also provides a method of loading contact information in a contact information database of a target device. The method can include requesting the contact information from a carrier information system, receiving the contact information at the target device and automatically loading the contact information into the contact information database of the target device. The contact information may include, for example, a phone number, a facsimile number, a physical address, an email address, a URL, directions to a location or an image.

Further, the invention provides a carrier information system for transferring information to at least one target device. The carrier information system can include a database that contains contact information and a processor coupled to the database. The processor can be programmed to receive a request for contact information from a requesting device. The processor can further be programmed to, in response to the request, access the contact information from the database and to cause the contact information to be transferred to the contact information database of the target device. As an example, the target device may be a wireless device, and the wireless device may be a mobile phone, a PDA or a gaming unit. The contact information may include, for example, a phone number, a facsimile number, a physical address, an email address, a URL, directions to a location or an image.

The processor may be further programmed to provide related information to the at least one target device. The related information may include, for example, directions to a physical address corresponding to the contact information, GPS co-ordinates of the physical address, an audio file corresponding to the contact information, a phonebook icon corresponding to the contact information or a signature ring tone corresponding to the contact information. Also, to provide directions to a physical address corresponding to the contact information to a target device, the processor may be further programmed to obtain the location of the target device, retrieve from the database the directions based on the location of the target device and to send the directions to the target device.

### BRIEF DESCRIPTION OF THE DRAWINGS

The features of the invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements.

FIG. 1 illustrates a flow diagram of a method for transferring information to at least one target device, in accordance with an embodiment of the invention.

FIG. 2 illustrates a flow diagram of a method for transferring information to a target device, in accordance with another embodiment of the invention.

FIG. 3 illustrates a flow diagram of a method for providing directions to a physical address to a target device, in accordance with an embodiment of the invention.

FIG. 4 illustrates a flow diagram of a method for loading contact information in a contact information database, in accordance with an embodiment of the invention.

FIG. 5 illustrates a block diagram of a carrier information system, in accordance with an embodiment of the invention.

### DETAILED DESCRIPTION OF THE INVENTION

While the specification concludes with claims defining the features of the invention that are regarded as novel, it is believed that the invention will be better understood from a consideration of the following description in conjunction with the drawing figures, in which like reference numerals are carried forward.

As required, detailed embodiments of the invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the invention in virtually any appropriately detailed structure. Further, the terms and phrases used herein are not intended to be limiting but rather to provide an understandable description of the invention.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Various embodiments of the invention provide a method and a carrier information system for transferring an object to at least one target device. The method can include receiving a request for contact information from a requesting device. The method can further include transferring at least a portion of the contact information to a contact information database of the target device in response to receiving the request. As a result, the contact information database of the target device may be updated over-the-air (OTA). The phrase “OTA” can mean that the information is transferred to at least one target device by a medium of broadcast transmission. Such a process can automatically load contact information into a user's wireless device when the user first requests the information. As such, the need to obtain this information in the future is eliminated, as the contact information will be stored in the user's wireless device.

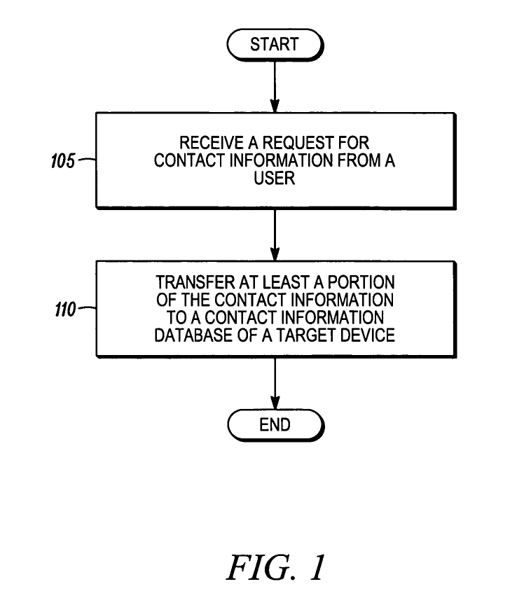

FIG. 1 illustrates a flow diagram of a method for transferring information to at least one target device, in accordance with an embodiment of the invention. The target device may be a wireless device, but it can be a hard-wired unit. The wireless device may be, for example, a mobile phone, a personal digital assistant (PDA), a digital camera, a media player or a gaming unit. At step 105, a request for contact information can be received from a requesting device. The contact information may include, for example, a phone number, a facsimile number, a physical address, an email address, a universal resource locator (URL), directions to a location or an image. The image may be, for example, a picture that can be used for caller identification or a symbol like a business trademark.

In an embodiment of the invention, the requesting device can be a target device to which the information can be transferred. It is understood, however, that the receiving device and the target device that will receive the contact information may be different components. In other words, a receiving device can request contact information for a completely separate communications device. In another embodiment of the invention, the target device can include at least one selective dynamic group call (SDGC)-device. An SDGC-device can belong to an SDGC group of the requesting device. SDGC generally refers to a multi-user private call where the originator of a call can select the participants before making the call. Through this exemplary process, contact information can be simultaneously transferred to a plurality of target devices. In yet another embodiment of the invention, the target device can include at least one related device, which can also enable a plurality of communication devices to receive the contact information. A reference corresponding to a related device can be stored in a profile of the target device. A related device can be, for example, that of a friend or a family member of the user of the requesting device, and the corresponding reference can be, for example, a Mobile Station Integrated Services Digital Network (MSISDN) number of the related device. Those of skill in the art will, however, appreciate that the invention is not limited to these examples of the related device and its corresponding reference, and the invention shall have full scope of the claims. Those of skill in the art will also appreciate that the invention is not limited to these embodiments of the target device, and the invention shall have full scope of the claims.

At step 110, at least a portion of the contact information can be transferred to a contact information database of the target device in response to the request from the requesting device. The contact information may be transferred using a communication protocol such as Synchronization Markup Language (SyncML) based protocol, although any other suitable protocol or technique may be employed here. The contact information database in the target device can then be automatically updated with the contact information requested. In an exemplary embodiment of the invention, the contact information database can be an address book of the target device. Those of skill in the art will, however, appreciate that the invention is not limited to this example of the contact information database, and the invention shall have full scope of the claims.

In an exemplary embodiment of the invention, additional target devices subscribed under any specific plan such as a family plan by the target device can be determined. The contact information can then be forwarded to one or more of the other target devices subscribed with the same target device. If one or more additional target devices are unavailable for the automatic update at the time of the request, the contact information is updated as these related target devices register with the relevant communication network.

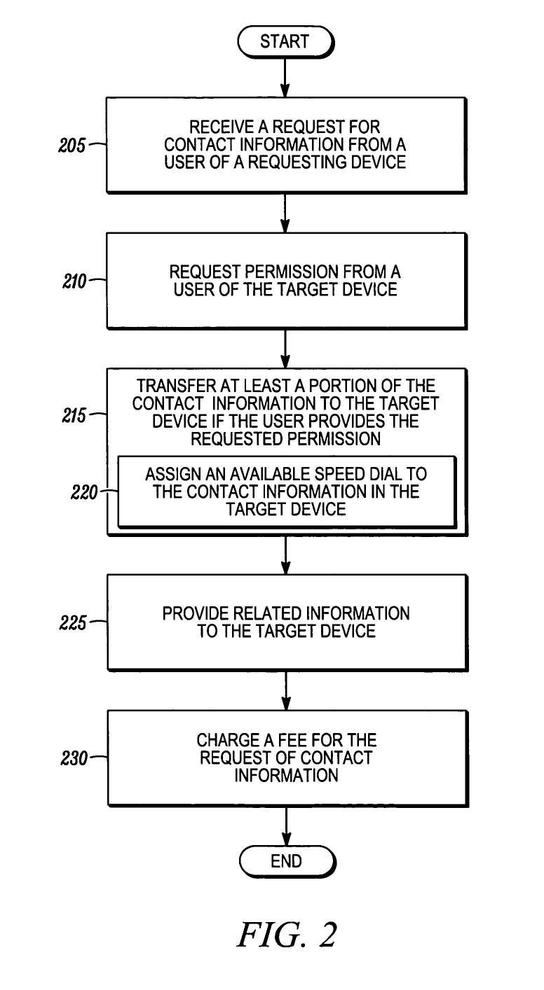

FIG. 2 illustrates a flow diagram of a method for transferring information to a target device, in accordance with another embodiment of the invention. At step 205, a request can be received for contact information from a user of a requesting device. At step 210, a request for permission for updating the contact information can be sent to the user of the target device. The method of sending the request for permission to the user of the target device will be apparent to a person skill in the art. At step 215, at least a portion of the contact information to the target device can be transferred if the user of the target device provides the requested permission. The step of transferring may include assigning an available speed dial to the contact information in the target device (at 220).

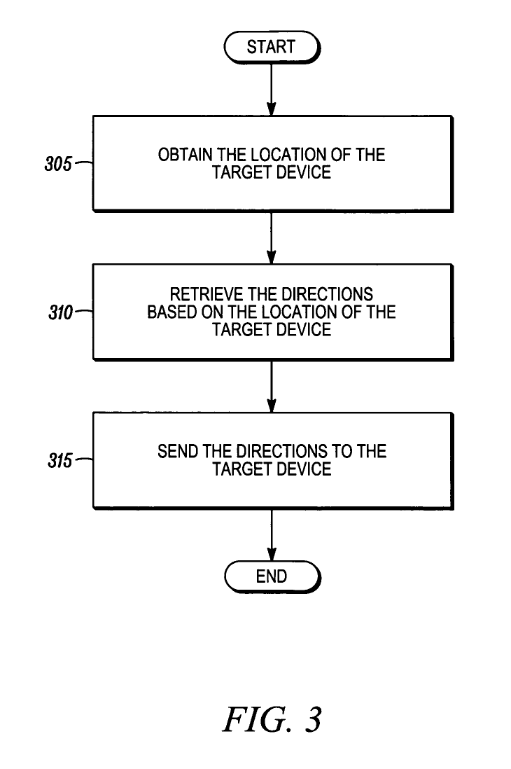

At step 225, related information can be provided to the target device. The related information may include, for example, directions to a physical address corresponding to the contact information, global positioning system (GPS) co-ordinates of the physical address, an audio file corresponding to the contact information, a phonebook icon corresponding to the contact information, or a signature ring tone corresponding to the contact information. The audio file may be for example, a podcast. The method for providing directions to the physical address to the target device has been explained in conjunction with FIG. 3.

At step 230, a fee can be charged for the request of contact information. In an embodiment of the invention, the fee is charged from the requesting device. For example, a consumer can pay USD 0.35 for an information call and an additional fee of USD 0.25 for requesting the transfer of the contact information to the contact information database of its wireless device. In another embodiment of the invention, the fee is charged from the target device. The fee can be paid to the entity that is providing the contact information, such as a wireless carrier service. It is also understood that the fee can be deducted from a prepaid account.

FIG. 3 illustrates a flow diagram of a method for providing directions to the physical address to a target device, in accordance with an embodiment of the invention. At step 305, a location of the target device can be obtained. The location of the target device may be obtained from, for example, a GPS system. As an example, the target device may include a GPS tracker, which can forward the positional information of the target device to the entity providing the contact information. At step 310, the directions to the physical address can be retrieved. At step 315, the directions can then be sent to the target device. These directions may then be displayed on the target device. As a result, the user of the target device can get the directions without retrieving the map and/or instructions for the physical address.

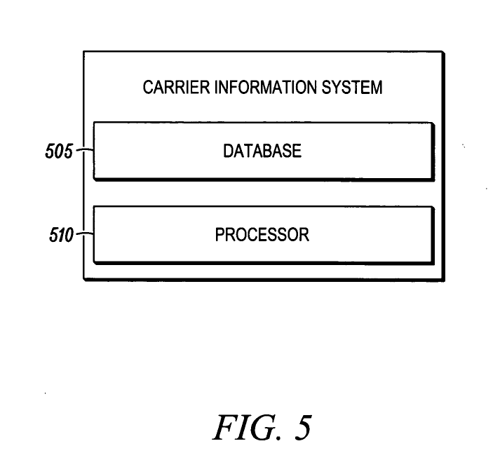

In various embodiments of the invention, a carrier information system can perform the methods explained in conjunction with FIG. 1, FIG. 2 and FIG. 3 to transfer information to at least one target device. This is further explained in conjunction with FIG. 5.

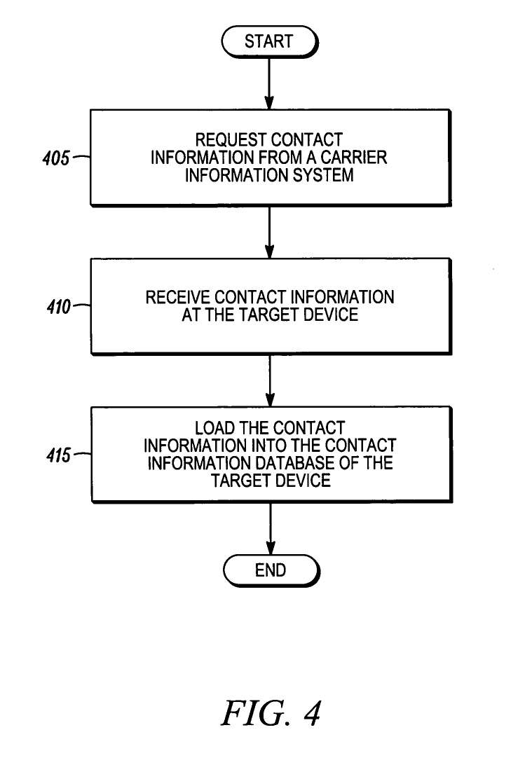

FIG. 4 illustrates a flow diagram of a method for loading contact information in a contact information database of the target device, in accordance with an embodiment of the invention. At step 405, a carrier information system can be requested for the contact information. The carrier information system can be requested, for example, by making an information call to an operator of the carrier information system or by sending a Short Service Message (SMS) to the carrier information system. The operator can be a human operator or a machine-based component. Those of skill in the art will, however, appreciate that the invention is not limited to these examples of the method for requesting the carrier information system, and the invention shall have full scope of the claims.

At step 410, the contact information is received at the target device and the contact information is automatically loaded into the contact information database of the target device, in accordance with step 415. In an embodiment of the invention, an available speed dial can then be assigned along with the contact information received from the carrier information system. Any suitable combination of hardware-based and software-based components in the target device can be used to perform these steps.

In an exemplary embodiment of the invention, the target device can enable the user to accept or reject any portion of the contact information, including any of the related information. Such an option can be displayed or broadcast on any suitable user interface of the target device. This option may also be supplied to the user of the requesting device, if the requesting device and the target devices are separate components.

In another exemplary embodiment of the invention, the target device can check for an address of an audio file, such as a podcast, associated with the contact information requested by the target device. The address of the podcast may be a URL or RSS (Really Simple Syndication) feed. The requesting device (or the target device) can be given an option to automatically update the podcast that can be transferred to the target device. In this case, if the podcast is updated on the carrier information system, it can be sent to the target device each time the target device registers for the user of the target device to hear the updated podcast.

FIG. 5 illustrates a block diagram of a carrier information system 500, in accordance with an embodiment of the invention. The carrier information system 500 can include a database 505 and a processor 510. The database 505 can include the contact information and can be part of any suitable memory. The processor 510 can be coupled to the database 505, although the processor 510 and the database 505 may be an integrated unit, if so desired.

The processor 510 can be programmed to receive a request for contact information from a requesting device. Also, the processor 510 can be programmed to access the contact information from the database 505 in response to the request for contact information. The processor 510 can be further programmed to cause the contact information to be transferred to the contact information database of the target device through any suitable transmission means, like a transceiver.

The processor 510 may be further programmed to provide related information to the at least one target device. The related information may include, for example, directions to a physical address corresponding to the contact information, GPS co-ordinates of the physical address, an audio file corresponding to the contact information, a phonebook icon corresponding to the contact information or a signature ring tone corresponding to the contact information. In an embodiment of the invention, to provide direction to a physical address corresponding to the contact information to the target device, the processor 510 can be further programmed to obtain the location of the target device, such as through the process described earlier in relation to FIG. 3. The processor 510 can then be further programmed to retrieve the directions based on the location of the target device and then send the directions to the target device. The processor 510 can retrieve the directions by generating them in accordance with any one of well-known algorithms in this technology area.

In an embodiment of the invention, the carrier information system 500 can provide a means for any type of target devices to register their additional information so it can be made available to other users. The carrier information system 500 can charge a one-time and/or periodic fee or pre-paid unit deduction to the target device and the subscriber or any other suitable entity for storing the contact information.

The various embodiments of the invention provide a method and carrier information system for automatically transferring contact information to the contact information database of the target device.

This disclosure is intended to explain how to fashion and use various embodiments in accordance with the invention rather than to limit the true, intended and fair scope and spirit thereof. The foregoing discussion is not intended to be exhaustive or to limit the invention to the precise forms disclosed. Modifications or variations are possible in the light of the above teachings. The embodiment(s) was chosen and described to provide the best illustration of the principles of the invention and practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitably entitled.

What is claimed is:

1. A method for transferring information to at least one target device, the method comprising:
receiving a request for contact information from a requesting device;
transferring at least a portion of the contact information to a contact information database of the target device in response to receiving the request.

2. The method of claim 1, wherein the target device comprises the requesting device.

3. The method of claim 1, wherein the target device comprises at least one selective dynamic group call (SDGC)-device, an SDGC-device belonging to an SDGC group of the requesting device.

4. The method of claim 1, wherein the target device comprises at least one related device, wherein a reference corresponding to the related device is stored in a profile of the target device.

5. The method of claim 1, wherein the target device is a wireless device, wherein the wireless device is a mobile phone, a personal digital assistant (PDA), a digital camera, a media player or a gaming unit.

6. The method of claim 1, wherein the contact information comprises a phone number, a facsimile number, a physical address, an email address, a universal resource locator (URL), directions to a location or an image.

7. The method of claim 1, wherein the transferring step comprises:
assigning an available speed dial to the contact information in the target device.

8. The method of claim 1, further comprising:
providing related information to the target device.

9. The method of claim 8, wherein the related information comprises directions to a physical address corresponding to the contact information, global positioning system (GPS) co-ordinates of the physical address, an audio file corresponding to the contact information, a phonebook icon corresponding to the contact information or a signature ring tone corresponding to the contact information.

10. The method of claim 9, wherein providing directions to the physical address to a target device comprises:
obtaining the location of the target device;
retrieving the directions based on the location of the target device; and
sending the directions to the target device.

11. The method of claim 1, further comprising:
requesting permission from a user of the target device; and
transferring at least a portion of the contact information to the target device if the user of the target device provides the requested permission.

12. The method of claim 1, further comprising charging a fee for the request of contact information.

13. A method of loading contact information in a contact information database of a target device, comprising:
requesting the contact information from a carrier information system;
receiving the contact information at the target device; and
automatically loading the contact information into the contact information database of the target device.

14. The method of claim 13, wherein the contact information comprises a phone number, a facsimile number, a physical address, an email address, a universal resource locator (URL), directions to a location or an image.

15. A carrier information system for transferring information to at least one target device, the carrier information system comprises:
a database that contains contact information; and
a processor coupled to the database, wherein the processor is programmed to:
receive a request for contact information from a requesting device;
in response to the request, access the contact information from the database; and
cause the contact information to be transferred to a contact information database of the target device.

16. The carrier information system of claim 15, wherein the contact information comprises a phone number, a facsimile number, a physical address, an email address, a universal resource locator (URL), directions to a location or an image.

17. The carrier information system of claim 15, wherein the processor is further programmed to:
provide related information to the at least one target device.

18. The carrier information system of claim 17, wherein the related information comprises directions to a physical address corresponding to the contact information, global positioning system (GPS) co-ordinates of the physical address, an audio file corresponding to the contact information, a phonebook icon corresponding to the contact information or a signature ring tone corresponding to the contact information.

19. The carrier information system of claim 18, wherein to provide directions to a physical address corresponding to the contact information to a target device, the processor is further programmed to:
obtain the location of the target device;
retrieve from the database the directions based on the location of the target device; and
send the directions to the target device.

20. The carrier information system of claim 15, wherein the target device is a wireless device, wherein the wireless device is a mobile phone, a personal digital assistant (PDA), a digital camera, a media player or a gaming unit.
